(19) United States
(12) Patent Application Publication
(10) Pub. No.: US 2006/0167632 A1
(43) Pub. Date: Jul. 27, 2006

(54) Navigation device, navigation system, navigation method, and program

(76) Inventors: Keisuke Ohnishi, Tokyo (JP); Shin Kikuchi, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/548,073

(22) PCT Filed: Feb. 19, 2004
(86) PCT No.: PCT/JP04/01877

§ 371 Date: Sep. 6, 2005

(30) Foreign Application Priority Data
Mar. 14, 2003 (JP) 2003-069297

(51) Int. Cl. G01C 21/26

(52) U.S. Cl. 701/213; 701/207; 701/209; 340/995.19

(57) ABSTRACT

A navigation device (10) of this invention has a position information reception unit (12), which obtains current position information from a GPS (20); a MAPDB (14), which stores map information; a direction detection sensor (17), which detects direction information; a input unit (16), which inputs search conditions; a communication control unit (13), which sends current position information to a navigation server (30), and obtains map information of a prescribed area from the navigation server (30); a central processing portion (11), which stores map information obtained by the communication control unit (13) into a MAPDB (14), in addition searches information of the desired surrounding area, based on map information, on direction information detected by a bearing censer (17), and on search conditions input from the input unit (16); and a display unit (15) for displaying the searched information of the surrounding area. By this means, a navigation device is provided, which is able to automatically and promptly search and provide information of the surrounding area only in the specified direction.

### TECHNICAL FIELD

This invention relates to a navigation device, system, method, and program for searching and providing information of the desired surrounding area. In particular, this invention relates to a navigation device, system, method, and program capable of automatically and promptly searching and providing information of the surrounding area only in the specified direction.

### BACKGROUND ART

Conventionally, there are navigation devices, portable telephones and similar which calculates the current position of vehicles and persons using position information from the GPS (Global Positioning System) and displays position information of the surrounding area.

Japanese Patent Laid-open No. 2001-356024 discloses a selection method for guiding information in a navigation display. In this method, among displayed information about plural institutions, at least one kind of institutions to request is specified (A condition setting step). Based on the specified kind of institutions, information of institutions in the prescribed area is retrieved (A destination area search step). Then retrieved institutions around the destination are listed and displayed (A list display step). Among the listed institutions, one institution is selected and set as a destination (A destination setting step).

In this way, based on the guide information, the institutions around the destination prepared at present are listed. Then, from the list, the final destination can be specified.

### DISCLOSURE OF THE INVENTION

However, according to the navigation method of Japanese Patent Laid-open No. 2001-356024, the current position and the destination are specified by a user, and based on the position of the destination, information of institutions in the prescribed area is retrieved. Thus, the direction from the present position to the destination has to be specified by a user, requiring a user to be aware of the relation between the user's position and the direction.

Particularly, when searching information of the surrounding area by a portable phone, a user has to decide the desired direction promptly. However, a user tends to take time to specify the direction and often makes mistakes. Thus, there are problems for a user to take time for searching the desired institutions in the surrounding area and the destinations. Hence, one object of this invention is to provide a navigation device, system, method, and program capable of automatically and promptly searching and providing information of the surrounding area only in the specified direction.

In order to attain this object, the navigation device of a first aspect of the invention is a navigation device which provides information of the surrounding area, having position information reception means for obtaining current position information; direction detection means for detecting direction information; input means for inputting search conditions; communication control means for sending current position information obtained by the position information reception means, and for obtaining map information of a prescribed area; central processing means for searching information of the desired surrounding area, based on map information obtained by the communication control means, on direction information detected by the direction detection means, and on search conditions input by the input means; and display means for displaying information of the surrounding area searched by the central processing means.

In order to attain this object, the navigation device of a second aspect of the invention is a navigation device which provides information of the surrounding area, having position information reception means for obtaining current position information; map information storage means for storing map information; direction detection means for detecting direction information; input means for inputting search conditions; communication control means for sending current position information obtained by the position information reception means, and for obtaining map information of a prescribed area; central processing means, for storing map information obtained by the communication control means into the map information storage means, and in addition for searching information of the desired surrounding area, based on map information, on direction information detected by the direction detection means; and on search conditions input by the input means; and display means for displaying information of the surrounding area searched by the central processing means.

Here, the direction detection means can be an electric compass or a gyro sensor.

Also, the navigation device can be a portable phone or a portable terminal.

In order to attain this object, the navigation system of the invention is a navigation system which provides information of the surrounding area, having a navigation device for specifying search conditions, and for displaying information of the surrounding area based on the search conditions; a GPS (Global Positioning System) for providing the navigation device with current position information; and a navigation server for providing the navigation device with map information of a prescribed range, based on current position information received from the navigation device; and characterized in that the navigation device is the navigation device described above.

Here, the position information reception means of the navigation device obtains current position information from the GPS.

In order to attain this object, the navigation method of the invention is a navigation method which provides information of the surrounding area, having the steps of (A) obtaining current position information; (B) sending current position information and obtaining map information of a prescribed area; (C) detecting direction information; (D) searching information of the desired surrounding area, based on obtained map information, on detected direction information, and on input search conditions; and (E) displaying searched information of the surrounding area.

Here, in step (B), obtained map information is stored.

Also, in step (A), current position information is obtained from the GPS.

In order to attain this object, a program of a first aspect of the invention is a program to provide a terminal device with information of the surrounding area, and is characterized in realizing in the terminal device the functions of navigation device described above.

In order to attain this object, a program of a second aspect of the invention is a program to provide a terminal device with information of the surrounding area, and is characterized in executing in the terminal device the functions of navigation method described above.

Automatically detecting the direction enables to automatically and promptly search and provide information of the surrounding area only in the specified direction.

### BRIEF DESCRIPTION OF THE DRAWINGS

FIG. 1 shows one example of a navigation system and device of this invention.

FIG. 2 shows a flowchart of a navigation method of this invention.

FIG. 3 shows one example of information search of a navigation method of this invention.

FIG. 4 shows a display example of a result of information search.

### BEST MODE FOR CARRYING OUT THE INVENTION

Below, aspects of a navigation device, system, method, and program of this invention are explained, referring to the drawings.

Of course, the scope of this invention is not limited to these aspects.

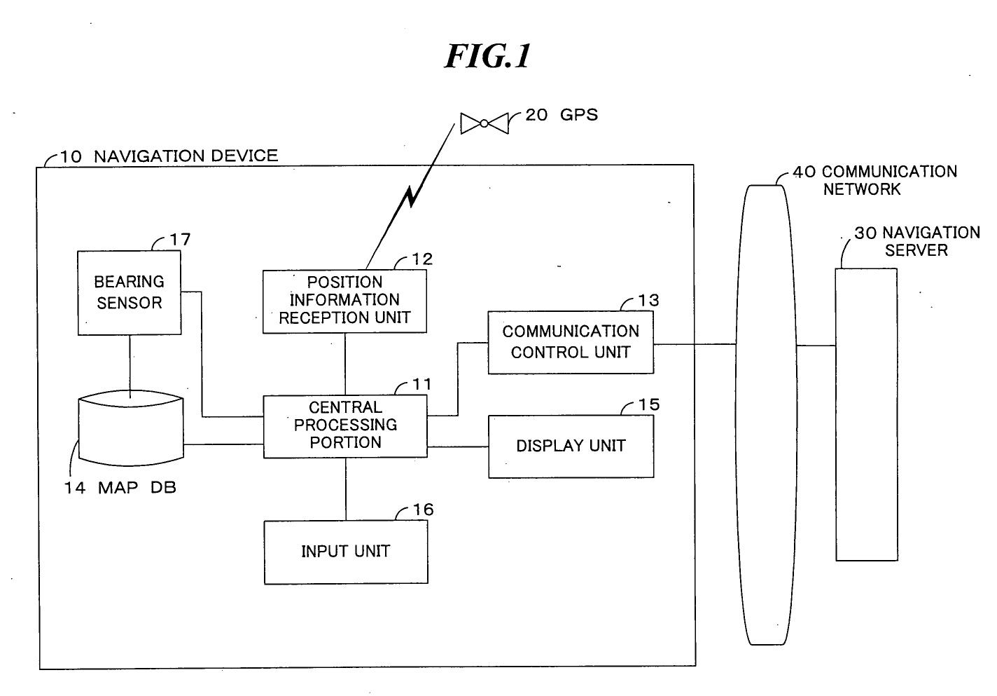

FIG. 1 shows one example of a navigation device and system of this invention. In FIG. 1, this navigation system has a navigation device 10, which specifies search conditions and displays information of the surrounding area based on search conditions; a GPS (Global Positioning System) 20, which provides navigation device 10 with current position information; a navigation server 30, which provides the navigation device 10 with map information of a prescribed area based on current position information received from the navigation device 10; and a communication network, which connects navigation device 10 and navigation server 30 to communicate.

Also, the navigation device 10 has a position information reception unit 12, which obtains current position information from a GPS 20; a MAPDB 14, which stores map information; a bearing sensor 17, which detects direction information; a input unit 16, which inputs search conditions; a communication control unit 13, which sends current position information obtained by the position information reception unit 12 to the navigation server 30, and obtains map information of prescribed area from the navigation server 30; a central processing portion 11, which stores map information obtained by the communication control unit 13 into the MAPDB 14, and in addition searches information of the desired surrounding area, based on map information, on direction information detected by the bearing sensor 17, and on search conditions input from the input unit 16; and a display unit 15, which displays information of the surrounding area searched by the central processing portion 11.

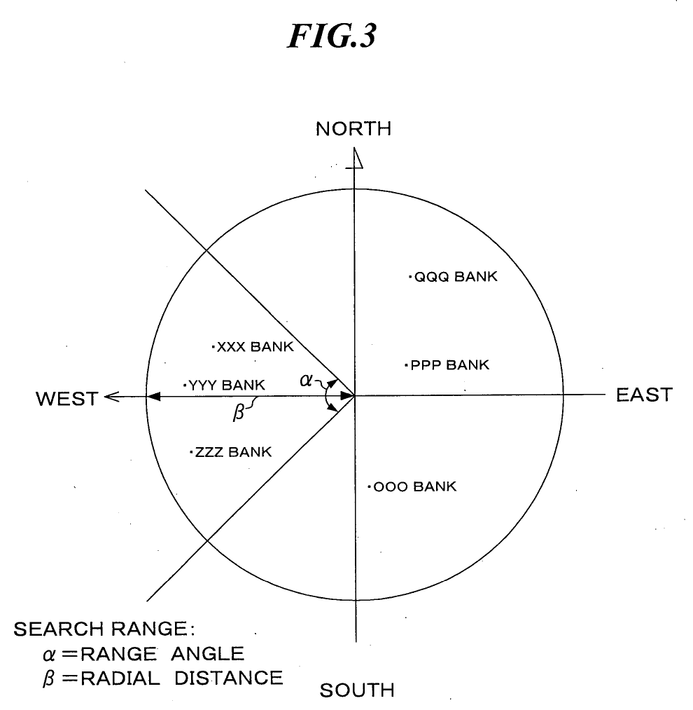

Here, the search conditions input from the input unit 16 can include a range to be searched (for example, β which is a radial distance from the current position, α which is a range angle from direction information (please refer to the FIG. 3 described hereafter), a name of a station ticket gate (West Gate, East Gate) and similar), a institution or name of the area as a destination (for example, XXBANK), a number of displaying items, distance to the destination (a straight distance or an actual distance along the roads), a priority order of the search conditions, and similar.

Also, the bearing sensor can be an electric compass or a gyro sensor, and a navigation device can include a portable phone and a portable terminal.

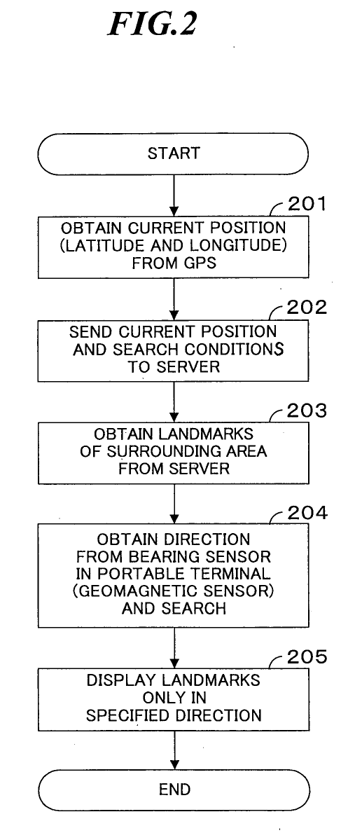

FIG. 2 is a flowchart showing the navigation method of a navigation system of this invention shown in FIG. 1. In FIG. 1 and FIG. 2, in accordance with an input of search conditions and an instruction to start navigation, the navigation will start.

The position information reception unit 12 obtains current position information (the latitude and longitude) from the GPS 20 (step 201).

Next, communication control unit 13 sends obtained current position information (the latitude and longitude) and search conditions to the navigation server 30 thorough the communication network 40 (step 202).

The navigation server 30 searches map information of the prescribed area (including landmarks of the surrounding area), based on the current position information (the latitude and longitude) and on search conditions which are sent form the navigation device 10, and sends map information to the navigation device 10. The communication control unit 13 of the navigation device 10 obtains map information (including landmarks of the surrounding area) from the navigation server 30 (step 203).

The central processing portion 11 stores obtained map information in the MAPDB 14, and in addition detects direction information by the bearing sensor 17, and searches information of the desired surrounding area, based on the obtained map information, on detected direction information, and on the input search conditions (step 204).

FIG. 3 shows one example of information search by the central processing portion 11. In FIG. 3, XXXBANK, YYYBANK, and ZZZBANK are searched as institutes (landmarks) based on the search conditions.

The display unit 15 displays information of the surrounding area searched by the central processing portion 11 (step 205).

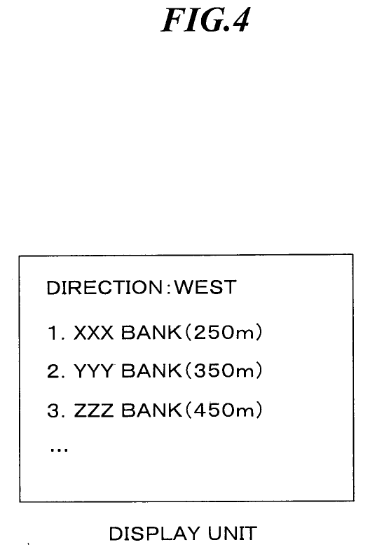

FIG. 4 shows one example of a display of information of the surrounding area searched based on the search conditions shown in FIG. 3. FIG. 4 shows information of the surrounding area (banks are specified as landmarks), listing the banks in the ascending order according to the distance from the current position.

In the above, a navigation device and method of this invention have been explained. A terminal device such as a portable telephone, portable terminal, and similar can be provided with a program for providing information of the surrounding area, and such a program can realize the functions of the above-described navigation device and execute the processes of the above-described navigation method in a terminal device.

As explained above, through a navigation device, system, method, and program of this invention, detecting the direction automatically enables to automatically and promptly search and provide information of the surrounding area only in the specified direction.

1-12. (canceled)

13. A navigation device for providing information of the surrounding area, comprising:
position information reception means for obtaining current position information;
map information storage means for storing map information of a prescribed area;
direction detection means for detecting direction information;
input means for inputting search conditions;
communication control means for sending said current position information obtained by said position information reception means, for sending said search conditions input by said input means, and for obtaining map information of the prescribed area;
central processing means for storing said map information of the prescribed area obtained by said communication control means, into said map information storage means, and in addition for searching information of the desired surrounding area, based on map information of the prescribed area stored in said map information storage means, on direction information detected by said direction detection means, and on search conditions including a search range input by said input means; and
display means for displaying said information of the surrounding area searched by said central processing means.

14. The navigation device according to claim 13, characterized in that said direction detection means is an electric compass.

15. The navigation device according to claim 14, characterized in that said navigation device is a portable telephone or a portable terminal.

16. A navigation system for providing information of the surrounding area, comprising:
a navigation device for specifying search conditions, and for displaying information of the surrounding area based on said search conditions;
a GSP (Global Positioning System) for providing said navigation device with current position information; and
a navigation server for providing said navigation device with map information of a prescribed range, based on said current position information received from said navigation device; and characterized in that said navigation device is the navigation device according to claim 14.

17. A program for allowing a terminal device to provide information of the surrounding area, which realizes in the terminal device the functions of the navigation devices according to claim 14.

18. The navigation device according to claim 13, characterized in that said direction detection means is a gyro sensor.

19. The navigation device according to claim 18, characterized in that said navigation device is a portable telephone or a portable terminal.

20. A navigation system for providing information of the surrounding area, comprising:
a navigation device for specifying search conditions, and for displaying information of the surrounding area based on said search conditions;
a GSP (Global Positioning System) for providing said navigation device with current position information; and
a navigation server for providing said navigation device with map information of a prescribed range, based on said current position information received from said navigation device; and characterized in that said navigation device is the navigation device according to claim 18.

21. A program for allowing a terminal device to provide information of the surrounding area, which realizes in the terminal device the functions of the navigation devices according to claim 18.

22. The navigation device according to claim 13, characterized in that said navigation device is a portable telephone or a portable terminal.

23. A navigation system for providing information of the surrounding area, comprising:
a navigation device for specifying search conditions, and for displaying information of the surrounding area based on said search conditions;
a GSP (Global Positioning System) for providing said navigation device with current position information; and
a navigation server for providing said navigation device with map information of a prescribed range, based on said current position information received from said navigation device; and characterized in that said navigation device is the navigation device according to claim 22.

24. A program for allowing a terminal device to provide information of the surrounding area, which realizes in the terminal device the functions of the navigation devices according to claim 22.

25. A navigation system for providing information of the surrounding area, comprising:
a navigation device for specifying search conditions, and for displaying information of the surrounding area based on said search conditions;
a GSP (Global Positioning System) for providing said navigation device with current position information; and
a navigation server for providing said navigation device with map information of a prescribed range, based on said current position information received from said navigation device; and characterized in that said navigation device is the navigation device according to claim 13.

26. The navigation system according to claim 25, characterized in that said position information reception means of said navigation device obtains said current position information from the GPS.

27. A program for allowing a terminal device to provide information of the surrounding area, which realizes in the terminal device the functions of the navigation devices according to claim 13.

28. A navigation method for providing information of the surrounding area, comprising the steps of:
(A) obtaining current position information;
(B) sending said current position information and search conditions, obtaining map information of a prescribed area, and storing map information of the prescribed area;
(C) detecting direction information;
(D) searching information of the desired surrounding area, based on said stored map information of the prescribed area, on said detected direction information, and on input search conditions including a search range; and
(E) displaying said searched information of the surrounding area.

29. The navigation method according to claim 28, characterized in that in said step (A), current position information is obtained from the GPS.

30. A program for allowing a terminal device to provide information of the surrounding area, which executes in the terminal device the process of the navigation method according to claim 29.

31. A program for allowing a terminal device to provide information of the surrounding area, which executes in the terminal device the process of the navigation method according to claim 28.
